(19) United States
(12) Patent Application Publication
(10) Pub. No.: US 2020/0107522 A1
(43) Pub. Date: Apr. 9, 2020

(54) GPS-ENABLED COLLAR WITH IMPROVED CHARGING

(71) Applicant: Sniffer GPS Inc., Atlanta, GA (US)

(72) Inventors: Reid Charles Kersey, Roswell, GA (US); Austin James Bush, Alpharetta, GA (US); Aaron Prakash Naidu, Tamil Nadu (IN); Austin Michael Morgan, Sandy Springs, GA (US)

(73) Assignee: Sniffer GPS Inc., Atlanta, GA (US)

(21) Appl. No.: 16/595,302

(22) Filed: Oct. 7, 2019

Related U.S. Application Data
(60) Provisional application No. 62/742,832, filed on Oct. 8, 2018.

(51) Int. Cl. A01K 11/00; G08B 21/02; G08B 3/10; G08B 21/18; A01K 27/00

(52) U.S. Cl. CPC A01K 11/008; G08B 21/023; G08B 21/0269; G08B 21/0272; G08B 21/0288; A01K 27/009; G08B 3/10; G08B 21/182; A01K 27/001; A01K 27/006; G08B 21/0261

(57) ABSTRACT

A system for tracking a location of a movable object can include a tracking device mounted to a collar. The tracking device can be configured to track its location using at least one of a global positioning system signal, a Bluetooth signal, and a Wi-Fi signal. The system can include a middle man charging mechanism. The middle man charging mechanism can be configured to receive electrical energy from a base station charging device. The middle man charging mechanism can be configured to store the received electrical energy. The middle man charging mechanism can be configured to couple to an external charging interface of the tracking device to recharge the battery included in the tracking device while the collar is worn by the movable object. The tracking device can also be configured to transmit information corresponding to the location of the tracking device to an external computing device.

### CROSS-REFERENCE TO RELATED APPLICATIONS

This application claims priority to U.S. provisional patent application Ser. No. 62/742,832 titled “GPS-Enabled Collar with Improved Charging” and filed on Oct. 8, 2018, the contents of which is incorporated herein by reference.

### BACKGROUND

The present invention relates generally to the field of allowing consumers to track their pets accurately and in real time while also conserving battery life of a tracking device. Tracking devices may use GPS tracking. Tracking devices may also have a significant trade off of accuracy for lower cost and battery life.

### SUMMARY OF THE INVENTION

One aspect of this disclosure is directed to a system for tracking a location of a movable object. The system can include a collar. The system can include a tracking device mounted to the collar. The tracking device can be configured to track its location using at least one of a global positioning system signal, a Bluetooth signal, and a Wi-Fi signal. The system can include a flexible solar panel mounted to the collar and electrically coupled with the tracking device. The solar panel can be configured to recharge a battery included in the tracking device. The system can include a middle man charging mechanism. The middle man charging mechanism can be configured to receive electrical energy from a base station charging device. The middle man charging mechanism can be configured to store the received electrical energy. The middle man charging mechanism can be configured to couple to an external charging interface of the tracking device to recharge the battery included in the tracking device while the collar is worn by the movable object. The tracking device can also be configured to transmit information corresponding to the location of the tracking device to an external computing device.

In some implementations, the tracking device further comprises a global positioning system module, a Bluetooth module, a cellular communications module, and a Wi-Fi module.

In some implementations, the tracking device is further configured to remove power from at least one of the global positioning system module, the Bluetooth module, the cellular communications module, and the Wi-Fi module responsive to an inactivity signal. In some implementations, the tracking device is further configured to supply power to at least one of the global positioning system module, the Bluetooth module, the cellular communications module, and the Wi-Fi module responsive to an activity signal.

In some implementations, the tracking device further comprises an accelerometer module configured to provide acceleration data, the inactivity signal, and the activity signal. The accelerometer module can be configured to provide the inactivity signal responsive to the acceleration data being below a predetermined threshold for a period of time, and provide the activity signal responsive to the acceleration data being above the predetermined threshold.

In some implementations, the tracking device further comprises a timer module configured to periodically provide the activity signal after a predetermined amount of time.

In some implementations, the battery electrically coupled to the tracking device resides inside the tracking device.

In some implementations, the tracking device is further configured to determine a remaining charge of the battery electrically coupled to the tracking device. In some implementations, the tracking device is further configured to transmit a notification to the external computing device responsive to the remaining charge being below a predefined charge threshold.

In some implementations, the tracking device is further configured to store a globally unique identifier.

In some implementations, the tracking device is further configured to determine the tracking device is not within range of a Wi-Fi network. In some implementations, the tracking device is further configured to receive global positioning system location data from the global positioning system module. In some implementations, the tracking device is further configured to transmit, to the external computing device via a cellular data network, the global positioning system location data using the cellular data module.

In some implementations, the tracking device is further configured to detect a Wi-Fi network is within a predetermined distance of the tracking device via a Wi-Fi signal received by the Wi-Fi module. In some implementations, the tracking device is further configured to create a Wi-Fi communication channel between the Wi-Fi network and the Wi-Fi module responsive to detecting the Wi-Fi network is within a predetermined distance of the tracking device. In some implementations, the tracking device is further configured to transmit, to the external computing device via the Wi-Fi communication channel, at least one of the Wi-Fi network name and the Wi-Fi network location using the Wi-Fi module.

In some implementations, the tracking device is further configured to detect an external Bluetooth module coupled to a mobile computing device within a predetermined distance of the tracking device via a Bluetooth signal received by the Bluetooth module. In some implementations, the tracking device is further configured to create a Bluetooth communication channel between the external Bluetooth module and the Bluetooth module responsive to detecting the external Bluetooth module is within a predetermined distance of the tracking device. In some implementations, the tracking device is further configured to receive configuration data from the mobile computing device via the Bluetooth communication channel. In some implementations, the tracking device is further configured to transmit, to the mobile computing device via the Bluetooth communication channel, the location of the tracking device.

In some implementations, the tracking device is further configured to detect a cellular tower within a predetermined distance of the tracking device via a cellular communications signal received by the cellular communications module. In some implementations, the tracking device is further configured to receive, from the cellular tower, triangulation information of the tracking device via the cellular communications module. In some implementations, the tracking device is further configured to track the location of the tracking device based on the received triangulation information.

In some implementations, the system can include a kinetic energy charging mechanism mounted to the collar and electrically coupled with the tracking device. The kinetic energy charging mechanism can be configured to produce an electrical charge in response to movement of the kinetic energy charging mechanism to charge the battery electrically coupled to the tracking device.

In some implementations, the system can include a flexible light tube comprising a light-emitting diode (LED) electrically coupled to the tracking device. In some implementations, the flexible light tube further comprises a flexible light guide mounted to the collar and coupled to the LED such that the light guide directs light emitted from the LED outward from the circumference of the collar.

In some implementations, the tracking device is further configured to illuminate the LED responsive at least one of a Bluetooth signal, a Wi-Fi signal, a cellular communications signal, and a global positioning system signal.

In some implementations, the tracking device is further configured to receive a boundary of a location defined by global positioning system coordinates from an external computing device via at least one of a Bluetooth signal, a Wi-Fi signal, and a cellular communications signal. In some implementations, the tracking device is further configured to store the boundary of the location in a data structure in computer memory.

In some implementations, the tracking device is further configured to determine the location of the tracking device is not within a predetermined region defined by global positioning system coordinates. In some implementations, the tracking device is further configured to illuminate the LED responsive to the determination that the tracking device is not within the predetermined region.

In some implementations, the system can include a speaker electrically coupled to the tracking device, wherein the tracking device is further configured to provide an audio signal to the speaker. In some implementations, the tracking device is further configured to provide an audio signal to the speaker responsive to the location of the tracking device not being within a predetermined region defined by global positioning system coordinates. In some implementations, the tracking device is further configured to provide an audio signal to the speaker responsive to the power of the Bluetooth signal falling below a predetermined threshold.

### BRIEF DESCRIPTION OF THE DRAWINGS

FIGS. 1A-1D show various views of an integrated collar and tracking device, according to an illustrative implementation.

FIG. 2 shows a view of a collar with a tracking device removed, according to an illustrative implementation.

FIGS. 3A and 3B show views of a tracking device, according to an illustrative implementation.

FIGS. 4A and 4B show exploded views of a collar, according to an illustrative implementation.

FIGS. 5A-5D show various stages of assembly of a collar, according to an illustrative implementation.

FIGS. 6A-6C show various views of a kinetic energy charging mechanism, according to an illustrative implementation.

FIG. 7 shows a flow diagram of an example method of managing power consumption by changing location tracking methods.

FIG. 8 shows a flow diagram of an example method of managing tracker information from an external computing device.

FIG. 9 shows a flow diagram of an example method of managing power consumption of a tracking device while in travel mode using Bluetooth.

FIG. 10 shows a flow diagram of an example method of sending tracking information to an external computing device.

### DETAILED DESCRIPTION

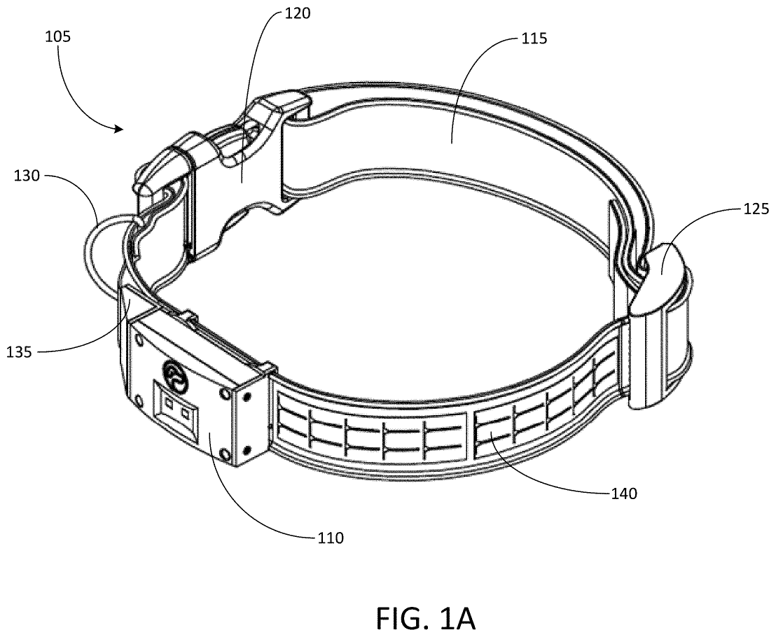

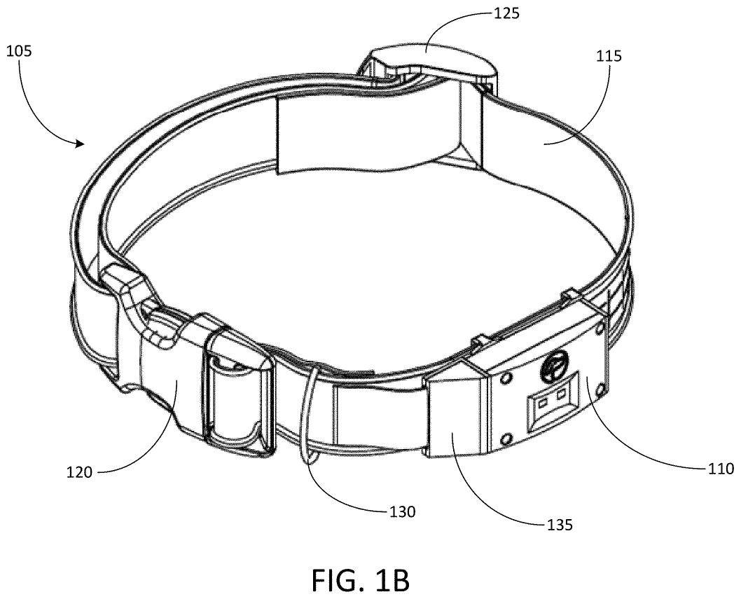

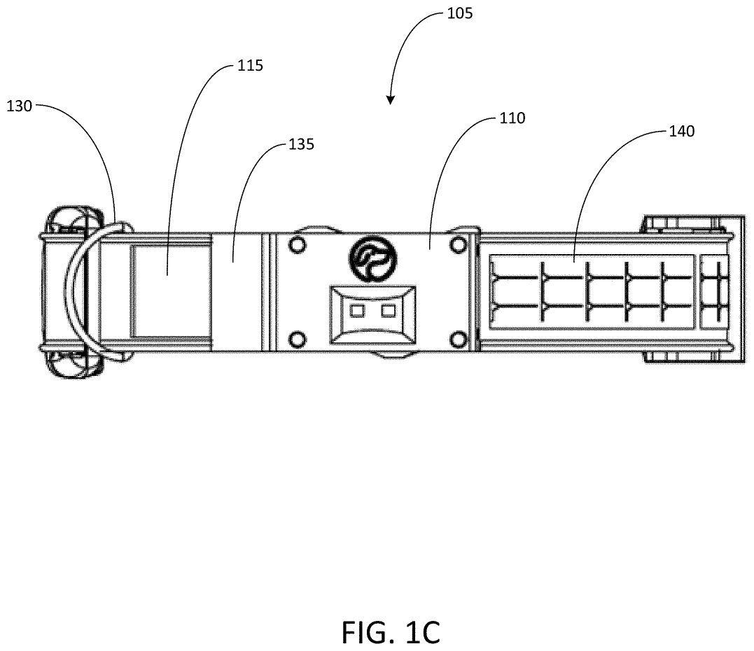

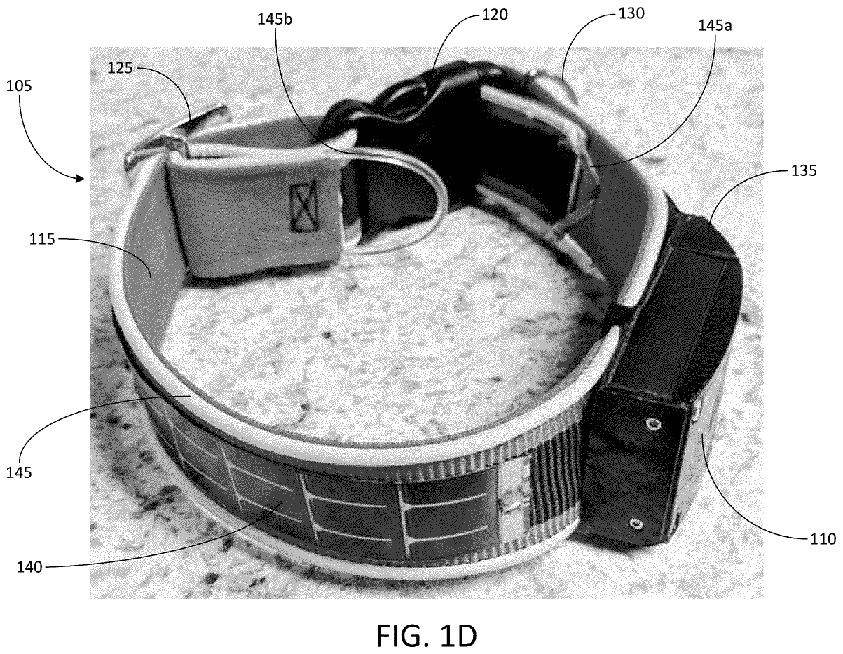

FIG. 1A shows a perspective view of an integrated collar 105 and tracking device 110, according to an illustrative implementation. FIGS. 1B-1C show various alternative views of the collar 105 integrated with the tracking device 110. Referring to FIGS. 1A-1D, the integrated collar 105 and tracking device 110 can be used together to track a location of a moving object. For example, in some implementations the collar 105 and tracking device 110 can be used to track a location of an animal, such as a dog or a cat. The collar 105 includes a flexible strap 115. The strap 115 can be coupled with a buckle 120, as well as an adjustment mechanism 125. An identification tag attachment mechanism 130 is coupled with the strap 115. The collar 100 also includes a device attachment mechanism 135, a solar panel 140, and a light tube 145.

The collar 105 can be configured to be secured to a moving object, such as the neck of an animal. Thus, the strap 115 of the collar 105 can be formed from a flexible material, such as a fabric or other textile material, or a flexible polymer material. In some implementations, the strap can be formed from a composite material, or from a combination of more than one material. For example, the strap 115 can be formed from two or more layers of different materials.

The buckle 120 can be configured to open or close a portion of the strap 115. For example, the buckle 120 can include two components (e.g., a male end and a female end) configured to be removable secured to one another so that the strap 115 can be fastened around and/or removed from the neck of an animal. The adjustment mechanism 125 can be configured to allow a length of the strap 115 to be adjusted. For example, a portion of the strap 115 can loop through the adjustment mechanism 125 so that the strap 115 can be lengthened by sliding the strap 115 through the adjustment mechanism 125. The identification tag attachment mechanism 130 can be secured to the strap 115. The identification tag attachment mechanism 130 can be made from a rigid material, such as a metal or alloy, and can form a loop for attaching an identification tag.

The tracking device 110 can be configured to track a location of a moving object. The tracking device 110 can be or can include one or more computing devices to perform such functionality. For example, the tracking device 110 can include a memory and one or more general purpose processors, as well as modules configured to perform location tracking, such as a global positioning system (GPS) module, a Wi-Fi module, a cellular communications module, a Bluetooth module, etc. The tracking device 110 can also include an integrated power source, such as a rechargeable battery. The tracking device 110 can be configured to determine its location, for example by receiving location information from one or more GPS satellites. The tracking device 110 can also be configured to determine its location based on information received from one or more cellular towers (e.g., triangulation information received by a cellular communications module of the tracking device 110), or based on information received from a Wi-Fi network or Bluetooth network having a fixed or known location. In some implementations, the tracking device 110 can be configured to select a technique for determining its location from among a plurality of possible techniques in a manner that helps to reduce power consumption and/or to conserve battery life of a rechargeable battery integrated into the tracking device 110.

For example, the tracking device 110 can use a combination of Cellular, Wi-Fi, and Bluetooth connectivity to connect to the internet and transmit its location coordinates, for example to an external computing device such as a smartphone, a tablet computing device, or a laptop computer. The external computing device can be operated by or otherwise accessible to a user, such as a pet owner whose pet wears the collar 105. Thus, the location coordinates determined or received by the tracking device 110 can correspond to the location of the user's pet. The tracking device 110 can use a variety of power-saving techniques to ensure that the tracking device 110 wastes as little power as possible and lasts as long as possible. To supplement power provided by an integrated battery, the tracking device 110 can receive power from the solar panel 140, for example via the device attachment mechanism 135.

The tracking device 110 can store or otherwise contain a globally unique identifier. For example, the globally unique identifier can be an alphanumeric character string stored in a memory element of the tracking device 110. The globally unique identifier can be derived from a MAC address of a Wi-Fi module included in the tracking device 110. The globally unique identifier can be encoded, for example, in BASE-64 to minimize the number of unique characters transmitted with every transmission.

In some implementations, the tracking device 110 can operate in a variety of modes selected to improve battery life. For example, the tracking device 110 can implement a sleep mode. The tracking device 110 can include one or more integrated sensors, such as one or more accelerometers. When an accelerometer detects no motion for a period of time, the accelerometer can generate an inactivity signal and the tracking device 110 can enter a sleep state. A lack of activity may indicate that an animal wearing the collar 105 has not moved, and therefore no new location information needs to be provided. In this state, the tracking device 110 can shut down all external and unneeded chips or modules, and may only turn them back on to transmit limited information, such as a “heartbeat” signal, at a regular pre-defined interval. For example, while in sleep mode a processor of the tracking device 110 can wake up once per second to make sure that no activity has been detected (e.g., by the accelerometer), and that neither Cellular or Wi-Fi modes need to be active. In some implementations, the tracking device 110 can wake up when acceleration beyond a predefined interval is detected (e.g., by the accelerometer). In some implementations, the tracking device 110 can wake up periodically based on an activity signal generated by a timer module.

The tracking device 110 may also operate in cellular, Wi-Fi, or Bluetooth modes. For example, a Bluetooth mode may be a primary of preferred mode of operation. The tracking device 110 may enter Bluetooth mode when it is within range of a Bluetooth module on an external computing device, such as a smartphone or other mobile device of a user (e.g., a pet owner whose pet wears the collar 105). In the Bluetooth mode, the tracking device 110 may be remotely accessed by the external computing device to allow the user to interact with the tracking device 110 via the external computing device. For example, the user may be able to access settings for the tracking device 110 and receive feedback from the tracking device 110 (e.g., current location information updated on a period basis) from the external computing device. In some implementations, the external computing device may execute or otherwise access an application (e.g., locally on the external computing device or remotely through a web browser that executes on the external computing device) that provides an interface through which the external computing device can send and receive information from the tracking device 110. For example, through the application, the user may be able to turn on a light indicator that may be integrated into either or both of the tracking device 110 or the collar 105, and may receive feedback, such as location information, from the tracking device 110.

The tracking device 110 may also be configured to operate in a Wi-Fi mode. In Wi-Fi mode, the tracking device 110 can attempt to detect a known Wi-Fi network within range. Then, if sensor data (e.g., accelerometer data) indicates that the tracking device 110 has moved, which can coincide with the activity of a pet wearing the collar 105, the tracking device 110 can connect to the Wi-Fi network periodically and can transmit information such as the name of the Wi-Fi network and a location of the Wi-Fi network (e.g., a street address associated with the Wi-Fi network), and other pertinent information to the external computing device operated by the user, or to a cloud-based application that may be accessible by the user via the external computing device. In the Wi-Fi mode, the tracking device 110 may be remotely accessed by the external computing device to allow the user to interact with the tracking device 110 via the external computing device. In some implementations, the external computing device may execute or otherwise access an application (e.g., locally on the external computing device or remotely through a web browser that executes on the external computing device) that provides an interface through which the external computing device can send and receive information from the tracking device 110. For example, through the application, the user may be able to turn on a light indicator that may be integrated into either or both of the tracking device 110 or the collar 105, and may receive feedback, such as location information, from the tracking device 110.

In some implementations, the tracking device 110 can also be configured to operate in a cellular mode. For example, when the tracking device 110 detects that it not within range of a known Wi-Fi network, and sensor data indicates that the tracking device 110 has moved, the tracking device 110 can be operated in the cellular mode. In the cellular mode, the tracking device 110 can periodically use its onboard GPS module to determine its GPS location, and can use its cellular module, which may include a modem, to transmit that location, along with other pertinent information to the external computing device operated by the user or to a cloud-based application accessible by the user via the external computing device. If GPS data is not available, the tracking device 110 may use its cellular module to determine its location via cellular tower triangulation, and may transmit that location information via the cellular module to the external computing device or to the cloud-based application. The tracking device 110 can also enter the sleep mode in between transmissions when in either cellular or Wi-Fi mode.

In some implementations, the tracking device 110 can also operate in an emergency solar power backup mode. For example, the tracking device 110 can enter this mode when the tracking device 110 has a nearly or fully depleted battery. The tracking device 110 can rely on the solar panel 140 to power and/or charge the battery. In some implementations, the tracking device 110 can stay in a deep sleep mode, for example with all chips and modules powered off, and can wake up the processor at periodic intervals to see if there is enough power in the battery to transmit a heartbeat signal or other signal to the external computing device or cloud-based application. If there is enough power to send such a signal, the tracking device 110 can use the stored energy in the battery to send a heartbeat signal, which may also include GPS coordinates, to the external computing device or cloud-based application. In some implementations, the tracking device 110 can then return to the sleep mode, for example based on a determination that the battery level is still below a threshold level for exiting the sleep mode.

In some implementations, the solar panel 140 can be or can include flexible solar cells attached around the circumference of the strap 115. The solar cells can be extremely flexible such that they can conform to the contours of the strap 115. For example, the solar panel 140 can run under the buckle 120 and/or the adjustment mechanism 125, and can be bent around the neck of an animal that wears the collar 105. This can help to ensure that the collar 105 is fully adjustable to the animal. In some implementations, the solar panel 140 can be or can include one or more MP3-25 solar cells, manufactured by PowerFilm Solar Inc. of Ames, Iowa.

In some implementations, the solar panel 140 can be electrically coupled with the tracking device 110 in order to provide supplementary power to a rechargeable battery included in the tracking device 110. For example, power supplied from the solar panel 140 may not be intended to serve as a primary source of power for the tracking device 110, but may enable the tracking device 110 to last significantly longer than it otherwise would, and can enable the tracking device 110 to have an emergency operating mode that supplies GPS location updates even when the battery is fully depleted, as described above.

In some implementations, the solar cells of the solar panel 140 can be wired in series. Wires can be coupled with the solar panel 140 and can run through a hole or opening in the strap 115 at the point labeled 145a in FIG. 1D to a middle layer of fabric. For example, this arrangement can help to ensure that the wires for the solar panel 140 are protected from the elements. The wires can then travel through the fabric of the strap 115, into the device attachment mechanism 135. At an opposite end labeled 145b in FIG. 1D, the light tube 145 can form a loop. The device attachment mechanism 135 can include an electrical and/or communications interface that couples with an electrical and/or communications interface of the tracking device 110. Thus, the tracking device 110 can receive electrical power from the solar panel 140 via the device attachment mechanism 135. In some implementations, the tracking device 110 can also transmit electrical power and/or communication signals to other components of the collar 105, such as a light tube 145 that can run along at least one edge of at least a portion of the strap 115. In some implementations, the flexible solar cells of the solar panel 140 can be configured such that they may be short circuited temporarily without causing any lasting damage to the solar panel 140. As a result, the collar 105 including the solar panel 140 can be washed without causing any lasting damage to the cells of the solar panel 140.

As illustrated, for example, in FIG. 1D, the collar 105 can include a light tube 145. The light tube 145 can run along one or both edges of the strap 115, and can be electrically coupled with the tracking device 110. For example, the light tube 145 can receive electrical signals from the tracking device 110 via the device attachment mechanism 135. In some other implementations, the light tube may be a passive element configured to guide light generated elsewhere through the light tube 145, such that the light is diffused throughout the light tube 145, thereby illuminating the light tube 145. For example, the device attachment mechanism 135 can include one or more light sources, such as light emitting diodes (LEDs) configured to direct light into the light tube 145. The LEDs can be controlled, for example by the tracking device 110, which can interface with the device attachment mechanism 135. Thus, in some examples, a user can interact with the tracking device 110 remotely via an external computing device to cause the tracking device 110 to activate the one or more LEDs included in the device attachment mechanism 135. In some implementations, the tracking device 110 can be configured to activate the one or more LEDs automatically, without an input from a user. For example, the tracking device 110 can be programmed to store the boundary of a location, which can be referred to as a geofence. In some implementations, the geofence can be defined by the area within which a selected Wi-Fi network (e.g., a user's home Wi-Fi network) has a signal strength above a predetermined threshold. In some implementations, the geofence can be defined by GPS or other location coordinates. When the tracking device 110 exits the geofence, the tracking device 110 can cause the LEDs to illuminate automatically, such that the collar 105 becomes more easily visible in the dark.

In some implementations, the LEDs can be configurable to produce any number of distinct colors. For example, the LEDs can produce hundreds or thousands of distinct colors, which may be selected by the user via an interface provided on the external computing device. In some implementations, the LEDs can be configured to produce at least 32,768 distinct colors. In some implementations, the LEDs can be configured to illuminate in at least one of four different operating modes: a steady mode, a rainbow mode, a flashing mode, and a dual color mode. The steady mode can be characterized by the LEDs maintaining a color constantly without any change. In some implementations, the steady mode color may be selected by the user via an interface provided on the external computing device. The rainbow mode is characterized by the LEDs changing to all possible colors in a periodic manner. The rainbow mode may be characterized by fading each color into the next color by varying the intensity of each LED. The flashing mode may be characterized by the LEDs flashing between two different colors at a defined periodic time interval. The two different colors and the periodic time interval may be selected by the user via an interface provided on the external computing device. The dual color mode may be characterized by the LEDs fading between two different colors at a predefined periodic time interval. The two different colors and the periodic time interval may be selected by the user via an interface provided on the external computing device. In some implementations, the user may select the operating mode of the LEDs via an interface provided on the external computing device. The operating mode of the LEDs can change responsive to an event. For example, if the location of the tracking device 110 is determined to be outside of a predetermined region of global positioning system coordinates, the LEDs can change from a steady operating mode to a flashing operating mode. The operating mode of the LEDs can change responsive to any event or user interaction described herein, or any other event related to the tracking device 110 or collar 105. The light tube 145 can receive the light from the LEDs and can diffuse the light throughout the light tube 145, to allow an animal wearing the collar 105 to be more visible in dark or low light conditions.

In some implementations, the collar 105 can include a speaker capable of producing audible or inaudible sound. The speaker can be electrically coupled to the tracking device 110, such that the tracking device can provide the speaker with an audio signal. The speaker can include its own audio signal module, and produce sound independent of the tracking device 110. The speaker can also be electrically coupled to the battery included in the tracking device 110, such that the battery can supply sufficient power to the speaker and/or audio signal module to produce sound. In some implementations, the tracking device 110 can provide an audio signal to the speaker responsive to one or more events. For example, an event can be a Bluetooth, Wi-Fi, cellular data, or global positioning system signal received by the tracking device 110. In some implementations, the tracking device 110 can be configured to provide an audio signal to the speaker such that it produces sound loud enough to be heard by a user from a sufficient distance, for example 200 feet away.

In some implementations, the tracking device 110 can be configured to provide the speaker with an audio signal responsive to the location of the tracking device being outside of a predetermined region of global positioning system coordinates (e.g., a geofence). In some implementations, the tracking device 110 can be configured to provide the speaker with an audio signal responsive to the power of a Bluetooth signal dropping below a predetermined threshold. For example, if an external Bluetooth module is paired with and communicating with the Bluetooth module of the tracking device 110, the tracking device 110 can query the signal strength (e.g., power) of the Bluetooth connection. If the queried power drops below a predetermined threshold, the tracking device 110 can provide speaker with an audio signal such that the speaker produces noise. This can be useful as an alarm in situations where the collar 105 may be out of sight of the user.

The tracking device 110 can include one or more activity sensors that can monitor the baseline activity of the pet wearing the collar 105. In some implementations, the activity sensors can include an accelerometer, a gyroscope, a magnetometer, a pedometer, a heartrate sensor, a breath rate sensor, a microphone, or other sensors used to determine the activity of a pet, animal, or other type of moveable object. The activity sensors can aggregate activity data of the pet by storing the activity sensor data, for example in a data structure in computer storage included in the tracking device 110. After aggregating the activity data, the tracking device 110 can be configured to apply filtering to the activity data to reduce the noise received in the data. For example, the activity data can be a signal taken with respect to time. One component of the activity data signals can be random noise. To reduce the noise, the tracking device can apply one or more filters (e.g., an FIR filter, down sampling, rolling averages, etc.) to the activity data. The tracking device 110 can also apply compression to the activity data to reduce its overall size. The tracking device 110 can be configured to apply compression before or after applying one or more filters to the activity data.

The tracking device 110 can transmit the activity data gathered by the one or more activity sensors to a backend computing device, for example a server. In some implementations, the tracking device 110 can transmit the activity data after applying one or more filters and/or one or more compression algorithms. The tracking device 110 can compress the activity data to reduce overall network utilization and power consumption when transmitting the activity data to the backend computing device, which is an improvement over other implementations. The tracking device 110 can transmit the activity data with a corresponding time stamp for each sample of the activity data. For example, the activity sensors may be configured to sample activity four times a second. Each activity sample can include a timestamp, which may be stored along with the activity data in a data structure and transmitted to a backend computing device. The backend computing device can further process the activity data by applying it to a diagnostic model to determine one or more abnormalities. The diagnostic model may be any type of machine learning module (e.g., linear regression, support vector machine, neural network, deep neural network, convolutional neural network, long short term memory, recurrent neural network, etc.). The diagnostic model may be a trained model, and may be trained using any type of training algorithm (e.g., stochastic gradient descent, batch gradient descent, mini-batch gradient descent, supervised learning, etc.). The diagnostic model can be trained used activity data of known pet health issues labelled with the respective health issue.

After training the diagnostic model, the model may be used to determine one or more health issues based on input activity data (e.g., the activity data from the activity sensors included in the tracking device 110). The diagnostic model may classify one or more health conditions, and may use a soft-max calculation to choose the final diagnosis. The diagnostic model may diagnose and/or classify, for example, heart conditions, breathing issues, depression, anxiety, sleeping problems, arthritis, other common health problems, or any other issue which may be determined based on the activity of a pet. The backend computing device can use the activity data received from the tracking device 110 to track the caloric consumption of the pet wearing the collar 105. The backend computing device can use the activity data to track the average activity of the pet wearing the collar 105 over the course of a period of time. The backend computing device can use the activity data to track the sleeping patterns of the pet wearing the collar 105. The backend computing device can provide the diagnosis, activity, and/or sleep information via a computer network to the external computing device. In some implementations, the backend computing device provides a web interface displaying the diagnostic, activity, and/or sleep information. In some implementations, the backend computing device can provide the diagnostic, activity, and/or sleep information to an application executed by the external computing device, for example via a computer network.

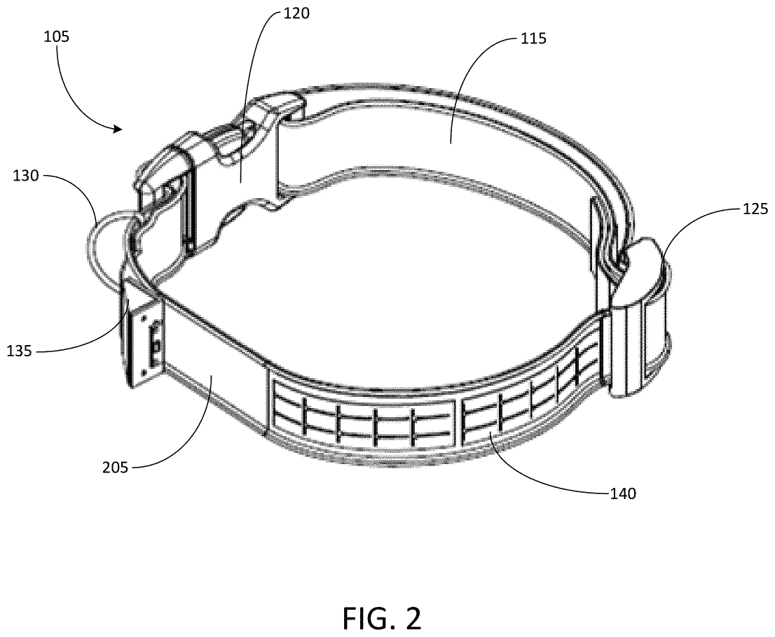

FIG. 2 shows a view of a collar 105 with a tracking device removed, according to an illustrative implementation. Thus, the tracking device 110 shown in FIGS. 1A-1D is not present in the collar 105 of FIG. 2. The collar 105 includes a mounting area 205 adjacent to the device attachment mechanism 135. The mounting area 205 provides a surface on which the tracking device 110 can be positioned when it is coupled with the device attachment mechanism 135. In the absence of the tracking device 110, the collar 105 can serve as a traditional pet collar. For example, the strap 115 can be fastened around the neck of an animal via the buckle 120, and its length can be adjusted via the adjustment mechanism 125. An identification tag for the animal can be fastened to the identification tag attachment mechanism 130. As a result, while functionality associated with the tracking device 110 (e.g., location tracking, activation of the light tube 145, etc.) may be unavailable with the tracking device 110 removed, the collar 105 can still serve as a traditional collar for a pet if it becomes necessary to temporarily or permanently remove the tracking device 110 from the collar 105 for any reason.

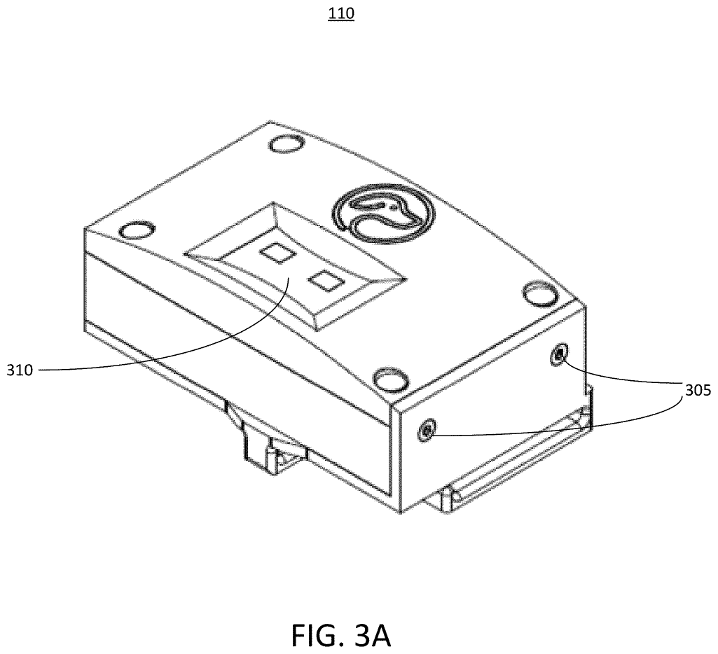

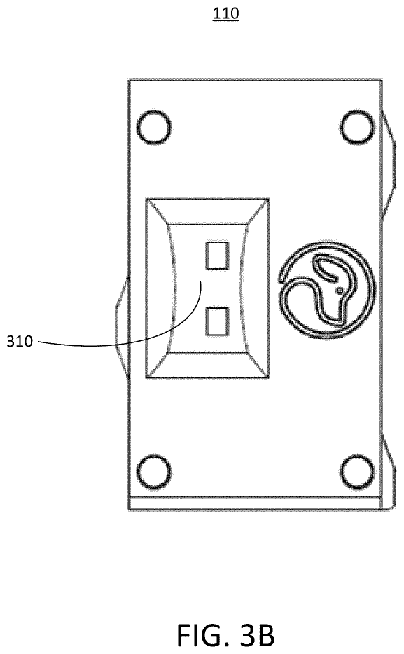

FIGS. 3A and 3B show views of the tracking device 110, according to an illustrative implementation. The tracking device 110 is shown unattached to the collar 105 in FIGS. 3A and 3B. In some implementations, the tracking device 110 can includes screws 305. The screws 305 can be configured to secure the tracking device 110 to the device attachment mechanism 135 when the tracking device 110 is mounted to be mounted on the collar 105. In some other implementations, the tracking device 110 can be secured to the device attachment mechanism 135 in a different manner, such as by press fitting, adhesive, or other mechanical fasteners. The tracking device 110 also includes an external charging interface 310. The external charging interface 310 can be configured to receive electrical power from an external power source, such as a wall outlet, cradle charger, or other charging element, such that an internal battery of the tracking device 110 can be recharged.

In some implementations, the external charging interface 310 can be configured to receive a “middle man” charging mechanism. The middle man charging mechanism can be coupled with the tracking device 110 even while the tracking device 110 is connected with the collar 105 and the collar 105 is being worn by an animal. Thus, the middle man charging mechanism can allow the pet to wear the collar 105 with the tracking device 110 continuously, even while the tracking device 110 is being charged, without being constrained to a fixed area due to a charging cable. In some implementations, the middle man charging mechanism can be charged on a base station by power from a wall outlet. For example, the base station itself can be coupled to the wall outlet by a charging cable, and the middle man charging mechanism can be charged by the base station.

The tracking device 110 can be charged by attaching the middle man charging mechanism to the tracking device 110 via the external charging interface 310. The middle man charging mechanism can be small enough and light enough to allow the pet wearing the collar 105 to have freedom of movement while the middle man charging mechanism is coupled to the external charging interface 310 of the tracking device 110. The middle man charging mechanism can use a stored charge to charge the internal battery of the tracking device 110, and can then be removed from the tracking device 110 and recharged via the base station. In some implementations, the tracking device 110 can be configured to transmit a notification to an external computing device when the charge level of its internal battery falls below a predetermined threshold, so that a user can be notified that the tracking device 110 should be recharged.

Traditional tracking devices and other wearable devices typically must be removed from the animal in order to be charged. For example, a standard method of charging such a device is to remove the device from the animal and put the device into a charging cradle that is plugged into the wall. For GPS tracking devices, this means that the animal is left unprotected when the tracking device is charging. This disclosure provides a solution to this technical problem by using an external middle man charging mechanism that can easily attach to the tracking device 110 on the collar 105 and can be removed from the tracking device 110 just as easily. Thus, the external charging mechanism acts a middle man between the base station and the tracking device 110. The middle man charging mechanism can take its stored charge from the base station that may be plugged into the wall, and uses the stored energy to charge the tracking device 110 while it is in use on the collar 105. Additionally, the tracking device 110 can continue to perform its normal functionality (e.g., tracking the animal's location) while charging. As a result, the tracking device 110 with the middle man charging mechanism can protect the animal for up to 100% of the time during the lifetime of the tracking device 110.

In addition, because the tracking device 110 can be removed from the collar 105, the tracking device 110 can also be used on its own or in connection with a different type of collar. For example, the tracking device 110 can be secured to a collar different from the collar 105 by any suitable means, and can still provide location tracking and charging functionality as described above. Another type of collar may not include a light tube 145, a solar panel 140, or a device attachment mechanism 135, however those elements may not be required for the location tracking functionality of the tracking device 110. Thus, the tracking device 110 can be used with other types of collars or other devices. In some implementations, the tracking device 110 can be placed in a container, such as a backpack or purse carried by a person, and therefore may serve as a way to track a location of the person.

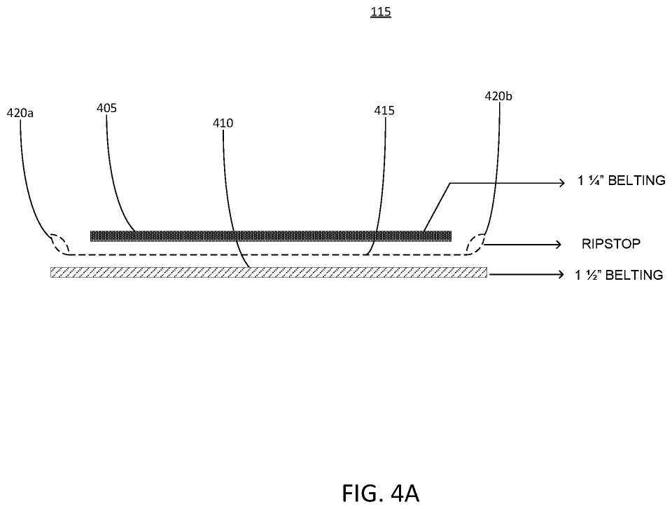

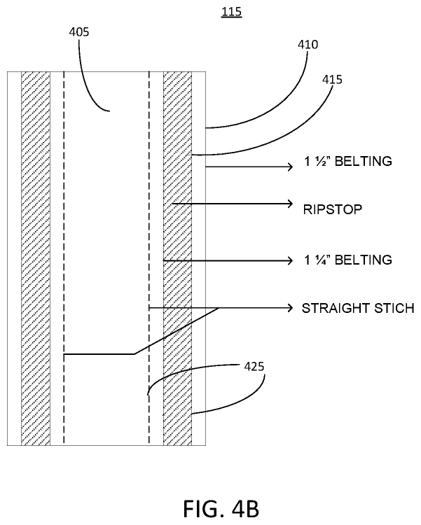

FIGS. 4A and 4B show exploded views of a strap 115 for a collar 105, according to an illustrative implementation. The strap 115 includes a first layer of fabric 405 and a second layer of fabric 410. For example, either or both of the first layer of fabric 405 and the second layer of fabric 410 can be or can include nylon fabric. The first layer of fabric 405 and the second layer of fabric 410 can be attached to one another via a layer of third layer of fabric 415. The third layer of fabric 415 can be formed from a ripstop material.

As illustrated in FIG. 4B, the first layer of fabric 405, the second layer of fabric 410, and the third layer of fabric 415 can be secured to one another via one or more stiches 425. A width of the first layer of fabric 405 can be smaller than a width of the second layer of fabric 410 and the third layer of fabric 415, such that a portion of the second layer of fabric 410 and the third layer of fabric 415 protrude outward beyond the edges of the first layer of fabric 405. It should be understood that the dimensions shown in FIGS. 4A and 4B are illustrative only. In some examples, any of the first layer of fabric 405, the second layer of fabric 410, and the third layer of fabric 415 may have dimensions that differ from those illustrated.

The third layer of fabric 415 includes loops 420a and 420b (generally referred to as loops 420) along its outer edges. The loops 420 are shown in cross-section in FIG. 4A. In some implementations, the loops 420 can be configured to provide a space through which the light tube 145 shown in FIG. 1D can pass. For example, the loops 420 can form channels into which at least a portion of the light tube 145 can be inserted. In some implementations, the third layer of fabric 415 can be formed from a translucent, transparent, or at least partially transparent material, such that light escaping from the light tube 145 also passes through the third layer of fabric 415. Thus, the light can be visible through the loops 420 of the third layer of fabric 415.

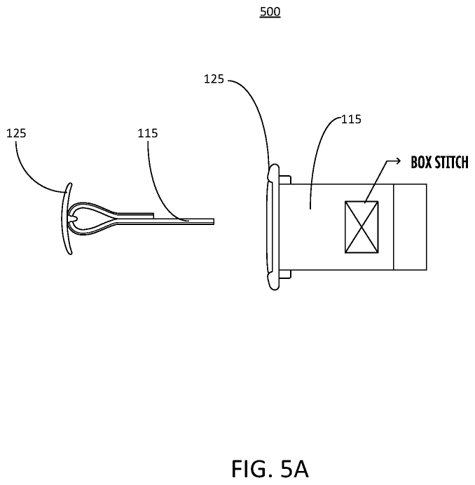

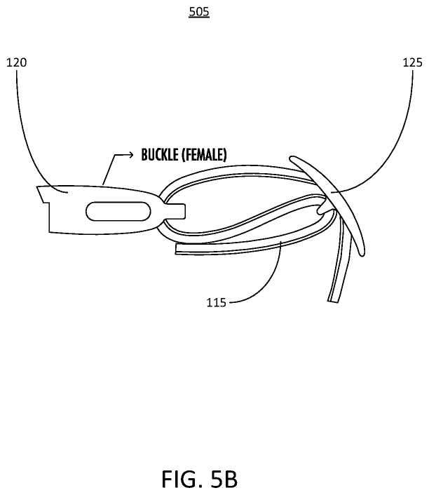

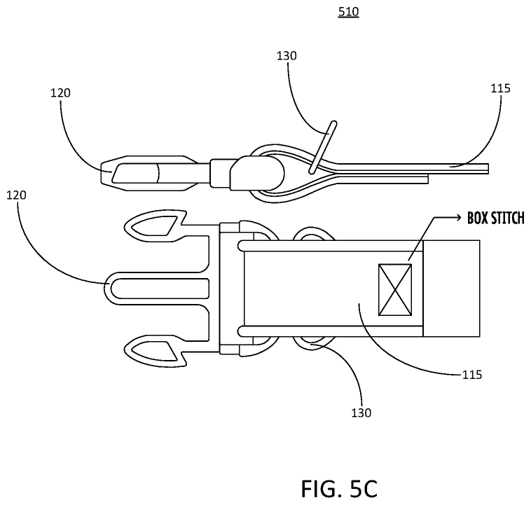

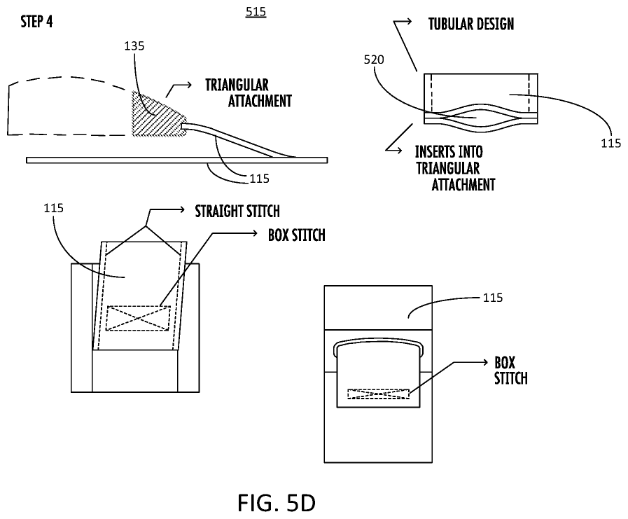

FIGS. 5A-5D show various stages of assembly of a collar, according to an illustrative implementation. In the stage 500 shown in FIG. 5A, the strap 115 is secured to a portion of the adjustment mechanism 125. For example, the strap 115 can be looped through a portion of the adjustment mechanism 125 and secured with stitching, such as a box stitch, as shown. In the stage 520 shown in FIG. 5B, a portion of the strap 115 is looped through the buckle 120 and then passed back through the adjustment mechanism 125. For example, the strap 115 can be looped through a female end of the buckle 120. Passing the strap 115 back through the adjustment mechanism 125 provides an arrangement in which the strap 115 can slide through the adjustment mechanism 125 to a desired position in order to achieve a desired length, which can be also be adjusted at any time.

FIG. 5C shows a stage 510 in which the strap 115 can be secured to another portion (e.g., a male end) of the buckle 120. For example, an end of the strap 115 opposite the end shown in stage 505 of FIG. 5B can be attached to the male end of the buckle 120. In some implementations, the strap 115 can loop through a portion of the male end of the buckle 120 and can be fastened, for example, with a box stitch. The identification tag attachment mechanism 130 can also be secured to the looped portion of the strap 115 at this end. FIG. 5D shows a stage 515 in which the strap 115 is coupled with the device attachment mechanism 135. As shown, at least a portion of the strap 115 can be formed in a tubular design that leaves a space 520 between two layers of material (e.g., any of the layers of material shown in FIGS. 4A and 4B). This tubular portion of the strap 115 can be inserted into the device attachment mechanism 135. In some implementations, the space 520 can provide room for electronic components, such as electrical leads or wires that may couple to circuitry in the device attachment mechanism 135 or in the solar panel 140. Thus, such electrical leads or wires can run through the 520 of the strap 115 into the device attachment mechanism 135 in order to protect the electrical leads or wires from the external environment.

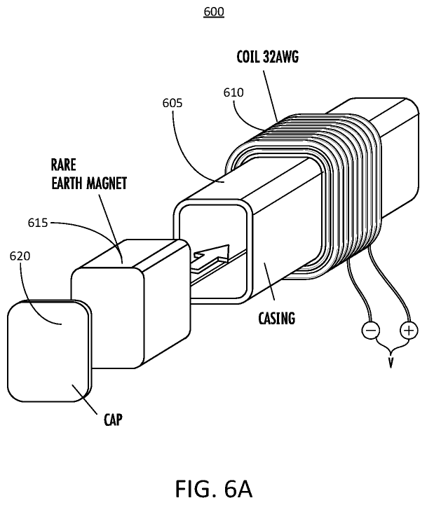

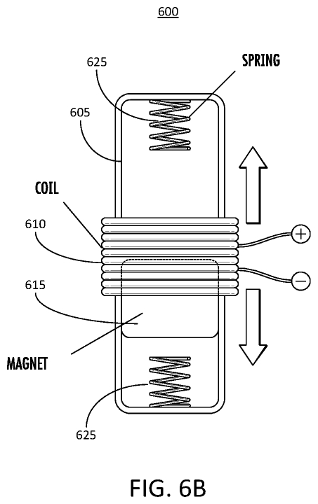

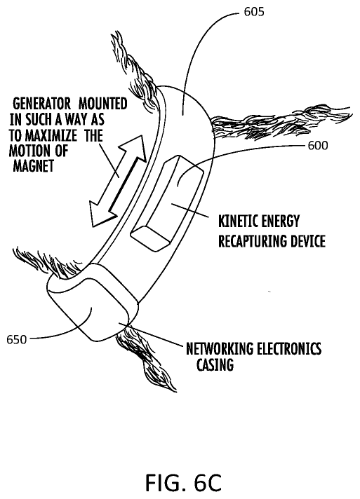

FIGS. 6A-6C show various views of a kinetic energy recapturing device 600, according to an illustrative implementation. The kinetic energy recapturing device 600 includes a tube 605 surrounded by a coil 610. The coil 610 can be formed from an electrically conductive material, such as a copper wire, that is wrapped around the tube 605. In some implementations, the coil 610 can include multiple layers. For example, the coil 610 can include 30 layers, with each layer including 100 turns. A magnet 615 is positioned inside the tube 605. A cap 620 secures the magnet 615 within the tube 610. As illustrated in FIG. 6B, a pair of springs 625 can be included at each end of the tube 605. The magnet 615 can be smaller than a length of the tube 605, allowing the magnet 615 to move linearly within the tube 605. Thus, when the kinetic energy recapturing device 600 itself moves, the magnet 615 can move within the tube 605, aided by forces imparted on the magnet 615 by the springs 625. In some implementations, the kinetic energy recapturing device 600 can be mounted on a collar 635, as illustrated in FIG. 6C. The collar 635 can be similar to the collar 105. For example, the collar 635 can include a tracking device 650, which may be similar to tracking device 110 described above. The collar 635 may also include a solar panel 140, a device attachment mechanism 135, a light tube 145, and other components described in connection with the collar 105.

In some implementations, the kinetic energy recapturing device 600 can be electrically coupled with the tracking device 650, for example via a connector similar to the device attachment mechanism 135. As the magnet 615 slides within the tube 605, a charge can be induced across opposite ends of the coil 610. In some implementations, this charge can be delivered to the tracking device 650, and can be used to recharge a battery included within the tracking device 650. Thus, motion of the kinetic energy recapturing device 600 (for example, due to movement of an animal wearing the collar 635 to which the tracking device 650 is mounted) can cause the kinetic energy recapturing device 600 to at least partially recharge the tracking device 650. As described above, the collar 635 may also include other elements, such as a solar panel, which may also be configured to charge the tracking device 650.

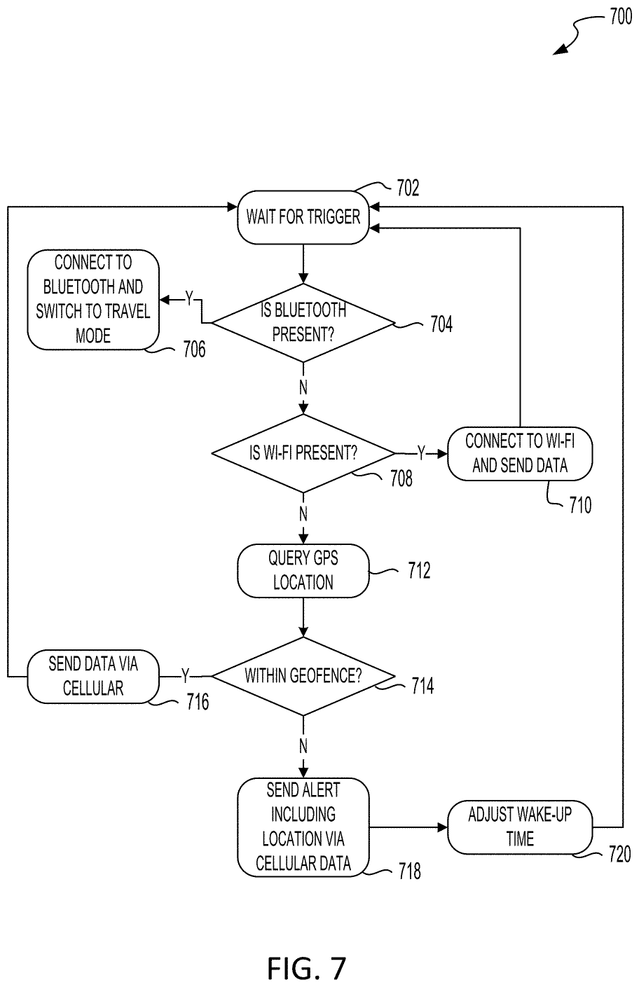

Referring now to FIG. 7, depicted is a flow diagram of a method 700 for managing power consumption by changing location tracking methods. The method 700 can be performed, for example, by the tracking device 110 detailed herein. In brief overview, the tracking device can wait for a trigger (702). The tracking device can determine whether Bluetooth is present (704). The tracking device can connect to Bluetooth and switch to travel mode (706). The tracking device can determine whether Wi-Fi is present (708). The tracking device can connect to Wi-Fi and send data (710). The tracking device can query a GPS location (712). The tracking device can determine whether the location is within a geofence (714). The tracking device can send data via a cellular data connection (716). The tracking device can send an alert including location via a cellular data connection (718). The tracking device can adjust the wake-up time 720.

In further detail of step (702), the tracking device (e.g., tracking device 110) can wait for a trigger. The trigger may be a counter that is configured to initiate the trigger after a predetermined period of time. The period of time can be, for example, ten minutes. While waiting for the trigger, the tracking device can be in a low-power sleep mode. The low-power sleep mode can be characterized by the removal of power from certain modules included in the tracking device. For example, the tracking device may remove power from the Bluetooth module, the Wi-Fi module, the cellular data module, and/or the GPS module while it is in sleep mode. Responsive to the trigger, the tracking device can exit sleep mode and execute other steps in the method 700, or other operations. Exiting sleep mode can include restoring power to one or more of the Bluetooth, Wi-Fi, cellular data, or GPS modules.

In further detail of step (704), the tracking device (e.g., tracking device 110) can determine if a Bluetooth device is present. The tracking device can send out a signal to attempt to connect to a known Bluetooth device. The tracking device can pair with one or more other Bluetooth devices within range of the Bluetooth module included in the tracking device. Another Bluetooth module can be determined to be present when a signal is received by the Bluetooth module included in the tracking device from another Bluetooth module external to the tracking device. If another Bluetooth device is determined to be present, the tracking device can execute step (706). If another Bluetooth device is not determined to be present, the tracking device can execute step (708).

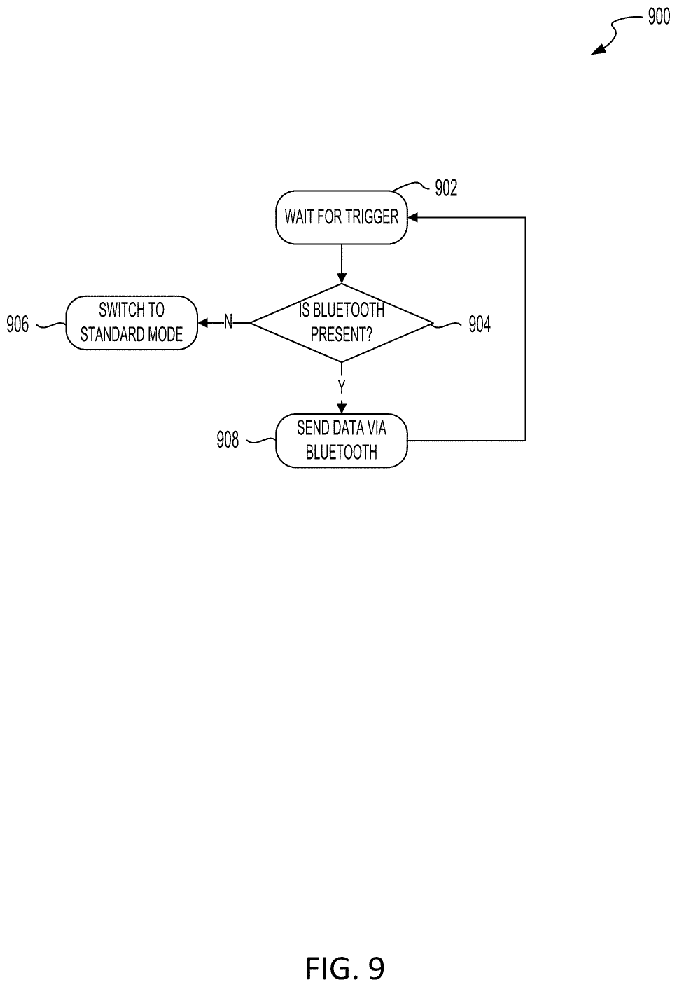

In further detail of step (706), the tracking device (e.g., tracking device 110) can connect to another Bluetooth device and switch to a travel mode. The tracking device can connect to the Bluetooth device detected in a previous step by pairing with the device. In some implementations, the tracking device can connect to another Bluetooth device without pairing with the device. The tracking device may already be paired with the other Bluetooth device, in which case the tracking device can quickly resume a connection with the other Bluetooth device. Switching to travel mode can include executing one or more steps of method 900 in conjunction with FIG. 9.

In further detail of step (708), the tracking device (e.g., tracking device 110) can determine whether a Wi-Fi network is present. Determining whether a Wi-Fi network is present can include scanning for a known service set identifier (SSID) by a Wi-Fi module, for example the Wi-Fi module included in the tracking device 110. Determining whether a Wi-Fi network is present can also include scanning for unknown and unsecured Wi-Fi networks in range of the tracking device. A known SSID can be provided to the tracking device from an external computing device, for example via cellular data, Wi-Fi, Bluetooth, or other communication methods. The tracking device can enumerate a list of Wi-Fi networks in range of the Wi-Fi module included in the tracking device. If a Wi-Fi network is detected, the tracking device can execute step (710) of method 700. If a Wi-Fi network is not detected, the tracking device can execute step (712) of the method.

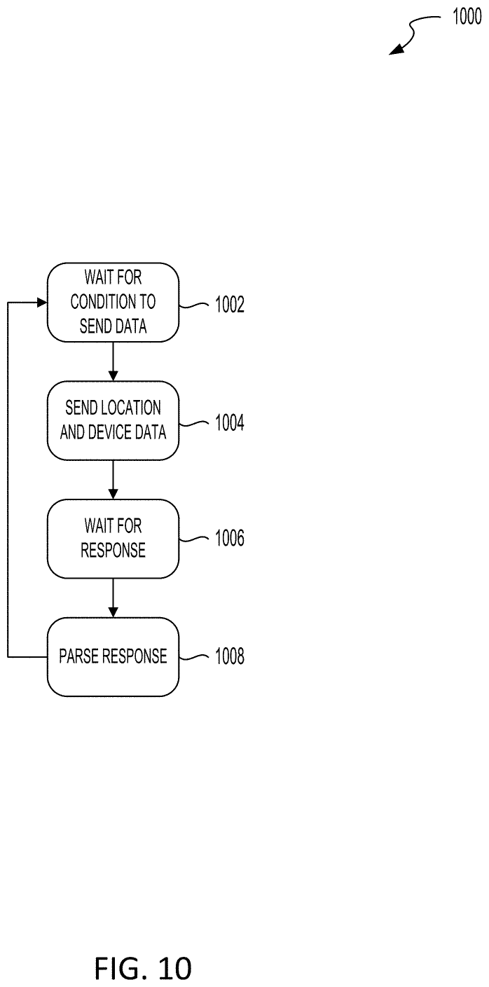

In further detail of step (710), the tracking device (e.g., tracking device 110) can connect to a Wi-Fi network and send data. The tracking device can connect to one of the Wi-Fi networks enumerated in step (708) of method 700. The tracking device can be configured only connect to a preferred network. The preferred network may be stored in configuration memory included in the tracking device. The preferred network may be provided to the tracking device from an external computing device, for example via cellular data, Wi-Fi, Bluetooth, or other communication methods. After connecting to the Wi-Fi network, the tracking device can send data as described in method 1000 in conjunction with FIG. 10. After the data is sent, the tracking device can continue to wait for another trigger. In some implementations, the wake-up time of the tracking device is reset to a default value, for example ten minutes.

In further detail of step (712), the tracking device (e.g., tracking device 110) can query a GPS location. The tracking device can query a GPS location using a GPS module, for example the GPS module included in tracking device 110. The tracking device can receive GPS coordinates from satellites using the GPS module. The tracking device can store the GPS coordinates in an internal memory, for example in a data structure.

In further detail of step (714), the tracking device (e.g., tracking device 110) can determine whether the GPS coordinates are within a predetermined geofence. The geofence can be a region of GPS coordinates stored within the tracking device. In some implementations, the tracking device can send the coordinates to an external computing device, and receive from the external computing device an indication of whether or not the coordinates are within the geofence. The geofence can be provided to the tracking device from an external computing device, for example via cellular data, Wi-Fi, Bluetooth, or other communication methods. If the GPS coordinates are within the geofence, the tracking device can execute step (716) of method 700. If the GPS coordinates are not within the geofence, the tracking device can execute step (718) of method 700.

In further detail of step (716), the tracking device (e.g., tracking device 110) can send data via a cellular data connection. The tracking device can connect to a nearby cellular tower using a cellular communication module, for example the cellular communication module included in the tracking device 110. The tracking device can be configured to automatically connect to the nearest cellular tower and open a communication channel. After connecting to the cellular data network, the tracking device can send data as described in method 1000 in conjunction with FIG. 10. After the data is sent, the tracking device can continue to wait for another trigger. In some implementations, the wake-up time of the tracking device is reset to a default value, for example ten minutes.

In further detail of step (718), the tracking device (e.g., tracking device 110) can send alert data via a cellular data connection. The alert data can include location data and an alert that an event has occurred or a condition has been met, for example the tracking device is determined to be outside of the geofence. The alert can include location data determined by the GPS module included in the tracking device. The tracking device can connect to a nearby cellular tower using a cellular communication module, for example the cellular communication module included in the tracking device 110. The tracking device can be configured to automatically connect to the nearest cellular tower and open a communication channel. After connecting to the cellular data network, the tracking device can send data as described in method 1000 in conjunction with FIG. 10. After the data is sent, the tracking device can continue to wait for another trigger. In some implementations, the wake-up time of the tracking device is reset to a default value, for example ten minutes.

In further detail of step (720), the tracking device (e.g., tracking device 110) can adjust the wake-up time of the tracking device. The wake-up time may be used to trigger the tracking device in step (702) method 700. The wake-up time may be an internal register value inside the tracking device. The wake-up time may be adjusted responsive to one or more events, for example determining that the tracking device is outside of a geofence. In some implementations, the wake-up time may be adjusted to a smaller value if the tracking device is determined to be outside of a predetermined area, for example a geofence. In some implementations, the wake-up time may be adjusted to be a larger value if the tracking device is determined to be inside of a predetermined area. Once the wake-up time is adjusted, the tracking device can go into a low-power sleep mode until a trigger has occurred.

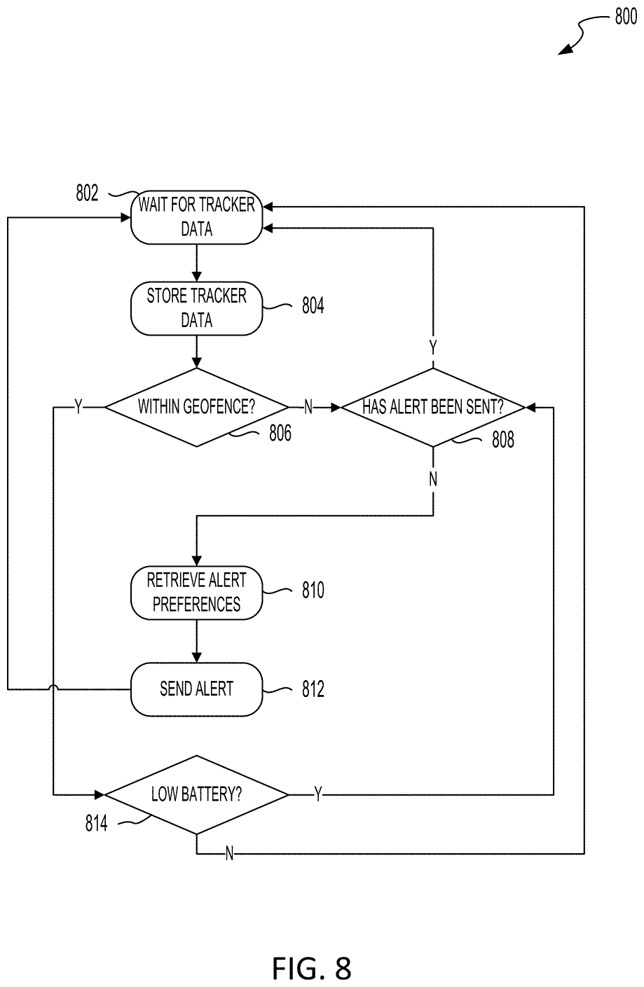

Referring now to FIG. 8, depicted is an example method 800 for managing tracker information from an external computing device. The method 800 can be performed, for example, by an external computing device, for example a server. In brief overview, the external computing device can wait for tracker data (802). The external computing device can store tracker data (804). The external computing device can determine whether location data is within a geofence (806). The external computing device can determine whether an alert has been sent (808). The external computing device can retrieve alert preferences (810). The external computing device can send an alert (812). The external computing device can determine whether the tracking device has a low battery (814).

In further detail of step (802), the external computing device can wait for tracker data. The tracker data can be received from a mobile device. The mobile device can interface and communicate with the tracking device via a Bluetooth connection. Tracker data can also be received from a computer network, for example the Internet, local area network, wide area network, or wireless network. The tracker data can include the location of a tracking device, for example the tracking device 110. The location of the tracking device can be global positioning system coordinates, coordinates of a Wi-Fi access point, or cellular tower triangulation data. The tracker data can also include a global identifier unique to the tracking device corresponding to the tracking data. The tracking data can also include an indication that an alert should be sent to another computing device related to the tracking device, for example another computing device used by the owner or user of the tracking device. The tracking data can include battery information about the corresponding tracking device, for example the percentage of battery remaining in the device, the total charge of the device, and/or the amount of time remaining before the battery is depleted. The tracking data can also include other information about the corresponding tracking device, for example the amount of time that it has been on, diagnostic information, current configuration information, information about other computing devices which may have interfaced with the tracking device, and other information related to the operation or configuration of the tracking device.

In further detail of step (804), the external computing device can store tracker data. The external computing device can store the tracker data received in step (802). The external computing device can store the tracking data in a computer storage medium, for example a database. The external computing device can store the tracker data in a structure. In some implementations, the external computing device can update tracker data that already exists in computer memory. In some implementations, the external computing device can store the tracker data in a data structure that corresponds to the global identifier included in the tracker data.

In further detail of step (806), the external computing device can determine whether the tracking data is within a geofence. The geofence can be a predetermined region of global position coordinates. Information about the geofence can be received by the external computing device from another computing device, for example via a computer network. The external computing device can store the geofence data in computer memory, for example a database. The external computing device can determine whether the tracking device corresponding to the tracker data is within the geofence by comparing the tracker data received in step (802) with the geofence data. For example, if the geofence data defines a region of global position system coordinates, the external computing device can compare the global positioning system coordinates received in step (802) with the geofence coordinates to determine whether the corresponding tracking device is within the region. If the external computing device determines the corresponding tracking device is within the geofence, the method 800 can proceed to step (814). If the external computing device determines that the corresponding tracking device is not within the geofence, the method 800 can proceed to step (808).

In further detail of step (808), the external computing device can determine whether an alert has been sent. The external computing device can maintain a log of all events which require an alert. The external computing device can maintain the log in a region of computer memory, for example in a data structure in a database. Along with events which require an alert, the external computing device can also store a value which corresponds to whether or not an alert has already been sent for the respective event. The external computing device can access the computer memory to read a value that corresponds to each event which require an alert. The external computing device can determine whether or not an alert has been sent by reading the value which corresponds to whether or not an alert has been sent for a respective event from the data structure. If the external computing device determines that an alert has already been sent for a corresponding event (e.g., the device is not within the geofence at a particular time or the battery is low), then the method can execute step (802). If the external computing device determines that an alert has not been sent for the corresponding event (e.g., the device is not within the geofence at a particular time or the battery for the tracking device is low), then the method can execute step (810).

In further detail of step (810), the external computing device can retrieve alert preferences. The alert preferences can correspond to a particular tracking device, and can be retrieved based on the global identifier included in the tracking data received in step (802). For example, the alert preferences may reside in a database, where each preference has a key value which corresponds to the global identifier of a tracking device. When alert preferences must be retrieved, the external computing device can use the global identifier received in step (802) as a key value (or index value) to access the region of memory which contains the corresponding alert preferences. The alert preferences can include email addresses, phone numbers, text message preferences, push notification information, addresses, and other preferences related to communication of alert messages.

In further detail of step (812), the external computing device can send an alert message. The alert message may be sent based on the alert preferences received in step (810), and the type of event which has occurred to require an alert. For example, the method 800 may determine that the battery of a tracking device is low. If the alert preferences include instructions to send a text message to a specific telephone number in the event of a low battery indication, the external computing device can send a text message to the number including the battery information of the tracking device. In another example, the method 800 may determine that the device is outside of the geofence. If the alert preferences include instructions to send an email to one or more email addresses when the tracking device leaves a geofence, then the external computing device can send an email to the one or more email addresses detailing the event. The alerts can include identifying information about the tracking device, tracking device location information, timestamps, and other tracking device information.

In further detail of step (814), the external computing device can determine whether the tracking device has a low battery. The external computing device can maintain configuration information about one or more tracking devices, for example tracking device 110. The configuration information can include a battery threshold value which corresponds to a low battery level. The configuration data can be stored in computer memory, for example in a database indexed by the global identifier of the tracking device. The external computing device can determine whether the battery of a particular tracking device is low by accessing the low battery threshold in the computer memory using the global identifier received in step (802), and comparing the low battery threshold to the battery information included in the tracker data received in step (802). If the external computing device determines that the battery level in the tracker data is below the low battery threshold, the method can proceed to step (808). If the external computing device determines that the battery level in the tracker data is not below the low battery threshold, the method 800 can proceed to step (802).

Referring now to FIG. 9, depicted is a flow diagram of a method 900 for managing power consumption of a tracking device while in travel mode using Bluetooth. The method 900 can be performed, for example, by the tracking device 110 detailed herein. In brief overview, the tracking device can wait for a trigger (902). The tracking device can determine whether Bluetooth is present (904). The tracking device can switch to standard mode (906). The tracking device can send data via Bluetooth (908).

In further detail of step (902), the tracking device (e.g., tracking device 110) can wait for a trigger. The trigger may be a counter that is configured to initiate the trigger after a predetermined period of time. The period of time can be, for example, ten minutes. While waiting for the trigger, the tracking device can be in a low-power sleep mode. The low-power sleep mode can be characterized by the removal of power from certain modules included in the tracking device. For example, the tracking device may remove power from the Bluetooth module, the Wi-Fi module, the cellular data module, and/or the GPS module while it is in sleep mode. Responsive to the trigger, the tracking device can exit sleep mode and execute other steps in the method 700, or other operations. Exiting sleep mode can include restoring power to one or more of the Bluetooth, Wi-Fi, cellular data, or GPS modules.

In further detail of step (904), the tracking device (e.g., tracking device 110) can determine if a Bluetooth device is present. The tracking device can send out a signal to attempt to connect to a known Bluetooth device. The tracking device can pair with one or more other Bluetooth devices within range of the Bluetooth module included in the tracking device. Another Bluetooth module can be determined to be present when a signal is received by the Bluetooth module included in the tracking device from another Bluetooth module external to the tracking device. If another Bluetooth device is determined to be present, the tracking device can execute step (908). If another Bluetooth device is not determined to be present, the tracking device can execute step (906).

In further detail of step (906), the tracking device (e.g., tracking device 110) can switch to standard mode. When no Bluetooth devices are available to connect to, the tracking device can connect to a Wi-Fi network or a cellular data network to communicate with an external computing device. In some implementations, the tracking device can connect to a Wi-Fi network or a cellular data network when in travel mode. Switching to travel mode can include executing one or more steps of method 700 in conjunction with FIG. 7. For example, switching to standard mode can include executing step (708) of method 700. In some implementations, switching to standard mode can include supplying power to one or more communications modules, for example the Wi-Fi module or the cellular communications module.

In further detail of step (908), the tracking device (e.g., tracking device 110) can send data via Bluetooth. The tracking device can send data to the device to which is connected via Bluetooth, for example the Bluetooth device found in step (904). The tracking device can send data to the Bluetooth device, including tracking data. In some implementations, tracking device can send information including the global identifier of the tracking device to the Bluetooth device. The tracking device can also send configuration information to the Bluetooth device, for example battery information, or information about current device settings, such as a current device timestamp. The tracking device can also send information about the status of the modules included in the tracking device to the Bluetooth device. In some implementations, the tracking device can send data in accordance with method 1000 in conjunction with FIG. 10.

Referring now to FIG. 10, depicted is a flow diagram of a method 1000 for sending tracking information to an external computing device. The method 1000 can be performed, for example, by the tracking device 110 detailed herein. In brief overview, the tracking device can wait for a condition to send data (1002). The tracking device can send location and device data (1004). The tracking device can wait for a response (1006). The tracking device can parse the response (1008).

In further detail of step (1002), the tracking device (e.g., tracking device 110) can wait for a condition to send data. While waiting for a condition to send data, the tracking device can be in a sleep mode. Sleep mode can be characterized by reduced power consumption, or by the removal of power from at least one of the Wi-Fi module, the Bluetooth module, the cellular communications module, or the global positioning system module. The condition to send data can include an indication that data needs to be sent, for example in accordance with steps (710), (716), or (718) of method 700 or step (906) of method 900. In some implementations, the condition to send data could be a periodic signal that generated after a predetermined amount of time, for example a signal generated by a timer. The timer can be configured to have a predetermined wake-up time.

In further detail of step (1004), the tracking device (e.g., tracking device 110) can send location and device data. The tracking device can send location and device data via at least one of the communication modules, for example the Wi-Fi module, Bluetooth module, or cellular communications module of the tracking device 110. The location data can include global positioning system coordinates received by a global positioning system module, for example the global positioning system module of tracking device 110. The location data can also include information about nearby Wi-Fi networks, information about nearby Bluetooth devices, cellular tower triangulation information, or past location information gathered by the tracking device. The location data can also include geofence information, for example a region of global positioning coordinates that define a geofenced area. The device data can include configuration information of the tracking device, for example the current timestamp of the device, the battery level of the device, battery capacity of the device, whether a middle-man charging apparatus is attached to the device, which modules are operational on the device, current power consumption of the device, device metadata, and other device information. The device data can also include a global identifier of the device, a serial number of the device, and other identifying information about the device and its component parts.

The tracking device can send the location and device data to an external computing device. The external computing device can be a Bluetooth device paired with the tracking device, for example a mobile device (e.g., smart phone, tablet, laptop computer, personal computing device, etc.), or any other type of computing device with Bluetooth capability. The external computing device can be a server that is connected to the internet, and the tracking device can send the location and device data using the Wi-Fi module or the cellular communications module. Using the Wi-Fi module, the tracking device can interface with a wireless access point that is connected to the Internet. The Wi-Fi module can send the location data and the device information via the Internet using the wireless access point. Using the cellular communications module, the tracking device can connect to a cellular data network, which is connected to the Internet. The cellular communications module can send the location data and the device information via the Internet using the cellular data network connection.

In further detail of step (1006), the tracking device (e.g., tracking device 110) can wait for a response from the external computing device. The response can include information about configuring the device, or other information related to the operations of the device. The response information can be handshake data that may be used to indicate to the tracking device that location data and device data were received by the external computing device. The response can also include information about the external computing device.

In further detail of step (1008), the tracking device (e.g., tracking device 110) can parse the response data received from the external computing device. Parsing the response data can include determining if updated tracking device configuration data is included in the response, and applying the updated configuration data to the tracking device. For example, the tracking device may receive a response including instructions to activate a light which is coupled to the tracking device. Upon parsing the response, the tracking device can apply power to the light to activate it. The response can also include information related to the operation of the device. For example, the response can include geofence information, or alert information. The response can also include updated configuration data for the device, for example firmware updates or other configuration updates. The tracking device can use the configuration data received in the response to update its internal configuration.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

As used herein, the term “about” and “substantially” will be understood by persons of ordinary skill in the art and will vary to some extent depending upon the context in which it is used. If there are uses of the term which are not clear to persons of ordinary skill in the art given the context in which it is used, “about” will mean up to plus or minus 10% of the particular term.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

The indefinite articles “a” and “an,” as used herein in the specification and in the claims, unless clearly indicated to the contrary, should be understood to mean “at least one.”

References to “or” may be construed as inclusive so that any terms described using “or” may indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence has any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A system for tracking a location of a movable object, the system comprising:
a collar;
a tracking device mounted to the collar, the tracking device configured to track its location using at least one of a global positioning system signal, a Bluetooth signal, a cellular communications signal, and a Wi-Fi signal;
a flexible solar panel mounted to the collar and electrically coupled with the tracking device, the solar panel configured to charge a battery electrically coupled to the tracking device;
a middle man charging mechanism configured to:
receive electrical energy from a base station charging device;
store the received electrical energy; and
couple to an external charging interface of the tracking device to charge the battery included in the tracking device while the collar is worn by the movable object, wherein the tracking device is configured to transmit information corresponding to the location of the tracking device to an external computing device.

2. The system of claim 1, wherein the tracking device further comprises:
a global positioning system module;
a Bluetooth module;
a cellular communications module; and
a Wi-Fi module.

3. The system of claim 2, wherein the tracking device is further configured to:
remove power from at least one of the global positioning system module, the Bluetooth module, the cellular communications module, and the Wi-Fi module responsive to an inactivity signal; and
supply power to at least one of the global positioning system module, the Bluetooth module, the cellular communications module, and the Wi-Fi module responsive to an activity signal.

4. The system of claim 3, wherein the tracking device further comprises an accelerometer module configured to provide acceleration data, the inactivity signal, and the activity signal, wherein accelerometer module is configured to provide the inactivity signal responsive to the acceleration data being below a predetermined threshold for a period of time, and provide the activity signal responsive to the acceleration data being above the predetermined threshold.

5. The system of claim 3, wherein the tracking device further comprises a timer module configured to periodically provide the activity signal after a predetermined amount of time.

6. The system of claim 1, wherein the battery electrically coupled to the tracking device resides inside the tracking device.

7. The system of claim 1, wherein the tracking device is further configured to:
determine a remaining charge of the battery electrically coupled to the tracking device; and
transmit a notification to the external computing device responsive to the remaining charge being below a predefined charge threshold.

8. The system of claim 1, wherein the tracking device is further configured to store a globally unique identifier.

9. The system of claim 2, wherein the tracking device is further configured to:
determine that the tracking device is not within range of a Wi-Fi network;
receive global positioning system location data from the global positioning system module;
transmit, to the external computing device via a cellular data network, the global positioning system location data using the cellular data module.

10. The system of claim 2, wherein the tracking device is further configured to:
detect a Wi-Fi network is within a predetermined distance of the tracking device via a Wi-Fi signal received by the Wi-Fi module;
create a Wi-Fi communication channel between the Wi-Fi network and the Wi-Fi module responsive to detecting the Wi-Fi network is within a predetermined distance of the tracking device; and
transmit, to the external computing device via the Wi-Fi communication channel, at least one of the Wi-Fi network name and the Wi-Fi network location using the Wi-Fi module.

11. The system of claim 2, wherein the tracking device is further configured to:
detect an external Bluetooth module coupled to a mobile computing device within a predetermined distance of the tracking device via a Bluetooth signal received by the Bluetooth module;
create a Bluetooth communication channel between the external Bluetooth module and the Bluetooth module responsive to detecting the external Bluetooth module is within a predetermined distance of the tracking device;
receive configuration data from the mobile computing device via the Bluetooth communication channel; and
transmit, to the mobile computing device via the Bluetooth communication channel, the location of the tracking device.

12. The system of claim 2, wherein the tracking device is further configured to:
detect a cellular tower within a predetermined distance of the tracking device via a cellular communications signal received by the cellular communications module;
receive, from the cellular tower, triangulation information of the tracking device via the cellular communications module; and
track the location of the tracking device based on the received triangulation information.

13. The system of claim 1, further comprising:
a kinetic energy charging mechanism mounted to the collar and electrically coupled with the tracking device, the kinetic energy charging mechanism configured to produce an electrical charge in response to movement of the kinetic energy charging mechanism to charge the battery electrically coupled to the tracking device.

14. The system of claim 1, wherein the system further comprises:
a flexible light tube comprising:
a multi-color light-emitting diode (LED) electrically coupled to the tracking device; and
a flexible light guide mounted to the collar and coupled to the multi-color LED such that the light guide directs light emitted from the LED outward from the circumference of the collar.

15. The system of claim 14, wherein the tracking device is further configured to:
illuminate the multi-color LED responsive at least one of a Bluetooth signal, a Wi-Fi signal, a cellular communications signal, and a global positioning system signal.

16. The system of claim 1, wherein the tracking device is further configured to:
receive a boundary of a location defined by global positioning system coordinates from an external computing device via at least one of a Bluetooth signal, a Wi-Fi signal, and a cellular communications signal;
store the boundary of the location in a data structure in computer memory.

17. The system of claim 14, wherein the tracking device is further configured to:
determine the location of the tracking device is not within a predetermined region defined by global positioning system coordinates; and
illuminate the LED responsive to the determination that the tracking device is not within the predetermined region.

18. The system of claim 1, wherein the system further comprises:
a speaker electrically coupled to the tracking device, wherein the tracking device is further configured to provide an audio signal to the speaker.

19. The system of claim 18, wherein the tracking device is further configured to:
provide an audio signal to the speaker responsive to the location of the tracking device not being within a predetermined region defined by global positioning system coordinates.

20. The system of claim 18, wherein the tracking device is further configured to:
provide an audio signal to the speaker responsive to the power of the Bluetooth signal falling below a predetermined threshold.
